(19) United States
(12) Patent Application Publication
(10) Pub. No.: US 2012/0038703 A1
(43) Pub. Date: Feb. 16, 2012

(54) INKJET PRINTING APPARATUS AND INKJET PRINTING METHOD

(75) Inventors: Akihiro Taya, Yokohama-shi (JP); Takeshi Okada, Zushi-shi (JP); Masanobu Ootsuka, Tokyo (JP); Tomomi Mimura, Kawasaki-shi (JP); Makoto Akahira, Yokohama-shi (JP)

(73) Assignee: CANON KABUSHIKI KAISHA, Tokyo (JP)

(21) Appl. No.: 13/186,560

(22) Filed: Jul. 20, 2011

(30) Foreign Application Priority Data
Aug. 3, 2010 (JP) 2010-174765

(51) Int. Cl. B41J 2/015

(52) U.S. Cl. 347/20

(57) ABSTRACT

A clear ink layer is formed by a first application of the clear ink. After a film of the clear ink is formed, a second application of the clear ink is performed onto the layer thereof. Thereby, a permeation speed of the clear ink which is applied at the second time after the clear ink is applied once becomes low, and becomes a substantially uniform one in the printed matter. That is, when the clear ink is applied at the second time onto the surface of the clear ink which is once formed into the film, the clear ink permeates therein at a substantially uniform permeation speed and is fixed thereto. As a result, the clear ink which is applied at the second time does not generate unevenness since the permeation speed thereof has no difference thereon, and can form a smooth printed matter surface.

### BACKGROUND OF THE INVENTION

1. Field of the Invention

The present invention relates to an inkjet printing apparatus and an inkjet printing method, and particularly relates to a construction for improving a gloss of a printed matter printed in ink.

2. Description of the Related Art

There is provided an inkjet printing apparatus which realizes high image fastness by using an ink using an aqueous dispersion pigment (hereinafter, called “a pigment ink”). However, a printed matter printed in a pigment ink generally has the characteristic of being excellent in water resistance and light resistance of an image, that is, fastness of the image, but being relatively low in the glossiness of the image. This is because the pigment ink hardly penetrates to the inside of a print medium, is fixed on the surface to form asperities on the surface of the print medium easily to impair smoothness of the image surface.

As an inkjet printing technology of improving the glossiness of an image by a pigment ink, Japanese Patent Laid-Open No. 2008-149514 describes the technology of improving non-uniformity of the glossiness on a printed matter caused by use of the pigment ink by applying a clear ink onto the printed matter. More specifically, by regulating an application amount of the clear ink in accordance with an application amount of the pigment ink, the difference in the gloss level due to the density of the pigment ink is decreased, and the glossiness on the printed matter using the pigment ink is made uniform.

Further, Japanese Patent Laid-Open No. 2001-039006 describes the technology of injecting a top coat solution formed from resin emulsion and water onto a surface of a printed matter to form a top coat layer thereon, thereby improving the glossiness of the printed matter using a pigment ink.

As the index for expressing the gloss level of a printed matter, “image clarity” showing the sharpness of a reflected image on the printed matter, and “specular gloss level” showing the brightness of the reflected image on the printed matter are often used. In order to realize the high gloss level equivalent to a silver halide photo and offset printing, both the image clarity and specular gloss level are desirably high.

The specular gloss level depends dominantly on a reflectance which is determined by a refractive index of a material of the printed matter surface and a surface roughness, and if a material with a high refractive index such as a resin is applied onto the printed matter surface, the specular gloss level can be improved. Meanwhile, the image clarity depends dominantly on smoothness on the printed matter surface, and in the printed matter using the pigment ink, the image clarity can be improved by smoothing the unevenness formed on the printed mater surface.

Japanese Patent Laid-Open No. 2008-149514 discloses the method for applying a clear ink onto a printed matter for the purpose of originally making the glossiness thereon uniform, and has the high effect of improving the sense of discomfort of an image due to uneven glossiness. However, Japanese Patent Laid-Open No. 2008-149514 is designed not to improve the gloss level itself to be higher but to make the glossiness uniform, and therefore, has the difficulty in realizing a high gloss level similar to that of the silver halide photo and the offset printing.

The technology described in Japanese Patent Laid-Open No. 2001-039006 can enhance a specular gloss level by using a resin as a coating layer of a printed matter. However, there are some cases where in the structure of simply applying a top coat solution or a clear ink onto a printed matter as described in Japanese Patent Laid-Open No. 2001-039006, the unevenness on the printed matter surface can not be smoothed. In such a case, the image clarity can not be enhanced, and therefore, realization of the high gloss level becomes difficult.

More specifically, on the printed matter by the pigment ink, the permeation speed of the clear ink differs depending on the kind and density of the applied pigment ink. When the permeation speed of the clear ink varies in this manner, since the resin of the clear ink flows into and deposits on a portion of the printed matter where the permeation speed is higher, a deposition amount of the clear ink resin also differs depending on the portion. Thus, simply by applying the clear ink onto the printed matter, the deposition amount thereof differs thereon, and as a result, in some cases the printed matter surface becomes uneven even though the clear ink is applied thereon.

### SUMMARY OF THE INVENTION

An object of the present invention is to provide an inkjet printing apparatus and an inkjet printing method which can improve glossiness, in particular, image clarity of a printed matter by a pigment ink.

In a first aspect of the present invention, there is provided an inkjet printing apparatus that uses a printing head for ejecting pigment ink containing a pigment as a coloring agent and clear ink containing no coloring agent and having film-forming property on a print medium and ejects ink from the printing head to the print medium for performing printing, the apparatus comprising: a printing unit configured to cause the printing head to eject a plurality of pigment inks, which contain different coloring agents from each other, from the printing head to the print medium for printing an image; a first applying unit configured to apply the clear ink to at least a part of a region of the image on the print medium, the region being printed by that the printing unit ejects the plurality of pigment inks that contain different coloring agents from each other, by causing the printing head to eject the clear ink to at least the part of the region; and a second applying unit configured to apply the clear ink to a region, to which the clear ink is applied by the first applying unit, by causing the printing head to eject the clear ink to the region, after the first applying unit applies the clear ink, wherein at least one time of application of the clear ink is performed by each of the first and second applying units.

In a second aspect of the present invention, there is provided an ink jet printing method that uses a printing head for ejecting pigment ink containing a pigment as a coloring agent and clear ink containing no coloring agent and having film-forming property on a print medium and ejects ink from the printing head to the print medium for performing printing, the method comprising: a printing step of causing the printing head to eject a plurality of pigment inks, which contain different coloring agents from each other, from the printing head to the print medium for printing an image; a first applying step of applying the clear ink to at least a part of a region of the image on the print medium, the region being printed by that the printing unit ejects the plurality of pigment inks that contain different coloring agents from each other, by causing the printing head to eject the clear ink to at least the part of the region; and a second applying step of applying the clear ink to a region, to which the clear ink is applied by the first applying step, by causing the printing head to eject the clear ink to the region, after the first applying step applies the clear ink, wherein at least one time of application of the clear ink is performed by each of the first and second applying steps.

According to the above configuration, after the clear ink which is applied at the first time becomes the film, the second application of the clear ink is performed. Thereby, the second clear ink permeates at a uniform permeation speed to be fixed. As a result, the clear ink which is applied at the second time does not generate unevenness on the surface since it has no difference in the permeation speed, and therefore, a smooth printed matter surface can be formed. Thereby, the glossiness, in particular, the image clarity of the printed matter can be improved.

Further features of the present invention will become apparent from the following description of exemplary embodiments (with reference to the attached drawings).

### BRIEF DESCRIPTION OF THE DRAWINGS

FIGS. 1A to 1D are diagrams for explaining a principle of the present invention;

FIG. 2 is a diagram showing a relationship between a surface coverage factor of a clear ink on a printed matter and image clarity;

FIG. 3 is a diagram showing a relationship between an application time difference in a first stage clear ink and a second stage clear ink, and image clarity;

FIG. 9 is a perspective view showing an outline of a printing part of a line head type inkjet printing apparatus usable in an embodiment of the present invention;

FIG. 5 is a perspective view showing an outline of a printing part of a serial type ink jet printing apparatus usable in the embodiment of the present invention;

FIG. 6 is a schematic diagram of a case of observing a printing head usable in the embodiment of the present invention from an ejection surface;

FIG. 7 is a diagram explaining nozzle blocks of a multi-pass in the printing head usable in the embodiment of the present invention;

FIG. 8 is a flowchart showing a printing operation of a first method which performs printing by a color ink and a two-stage clear ink application according to the embodiment of the present invention;

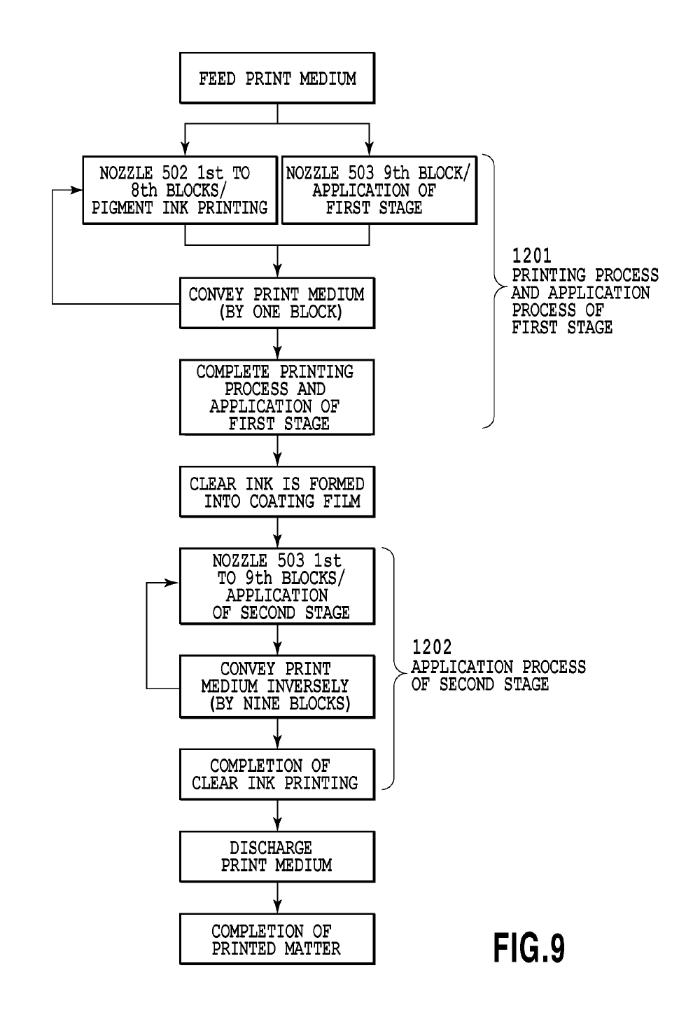

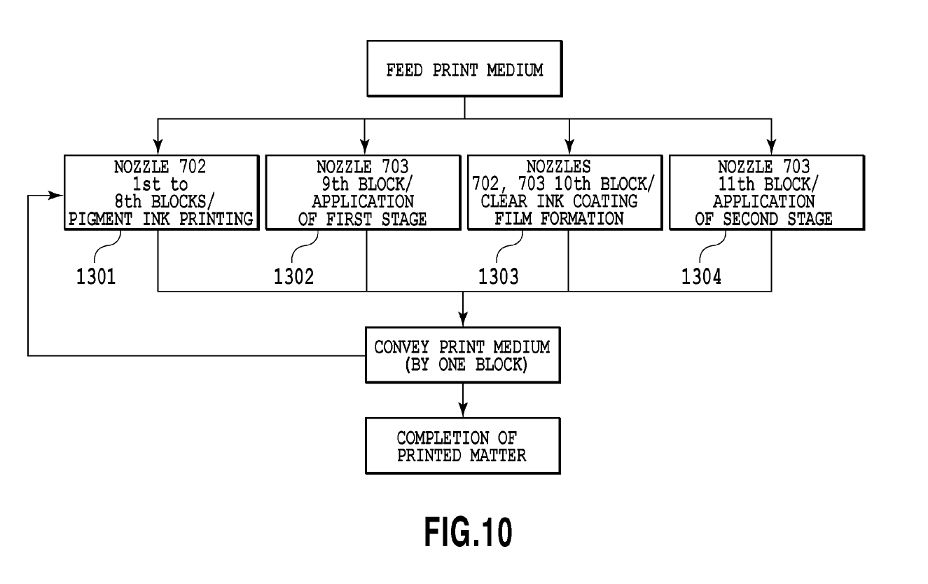

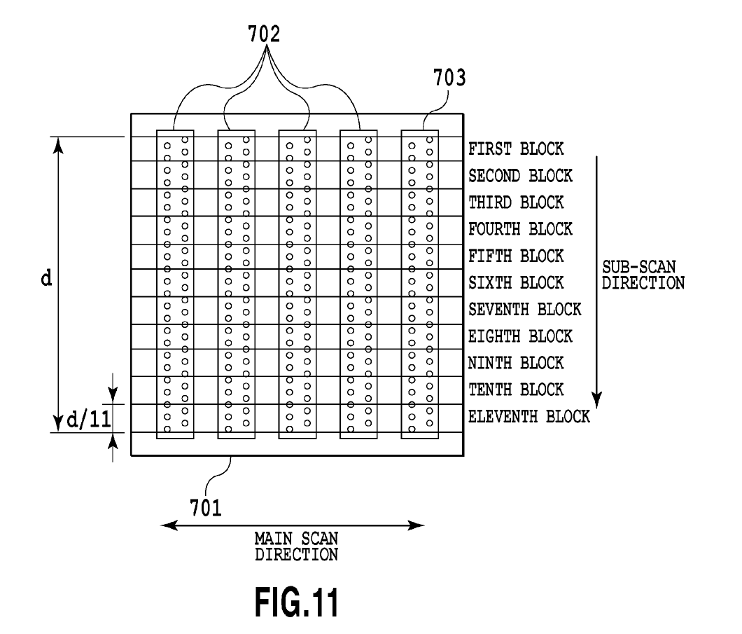

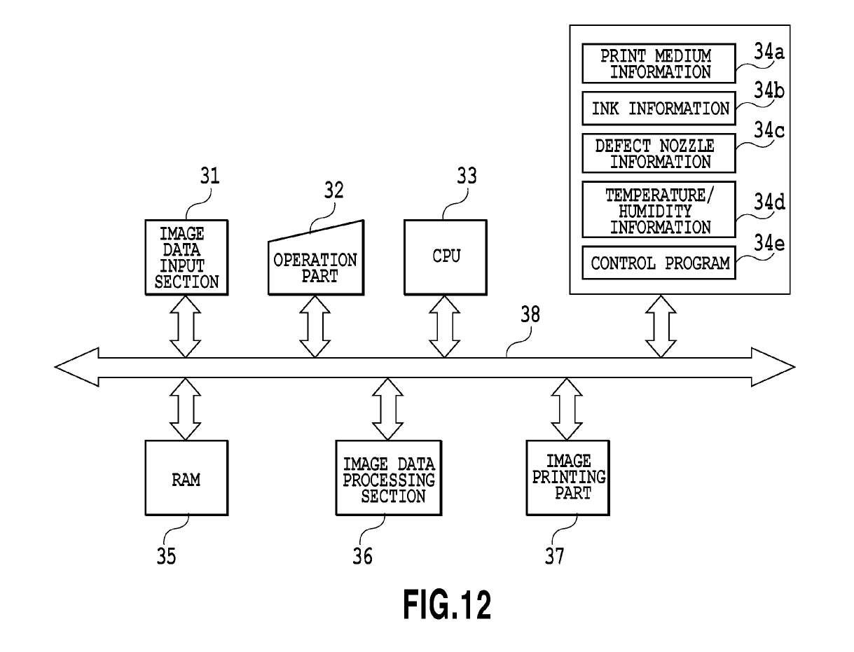

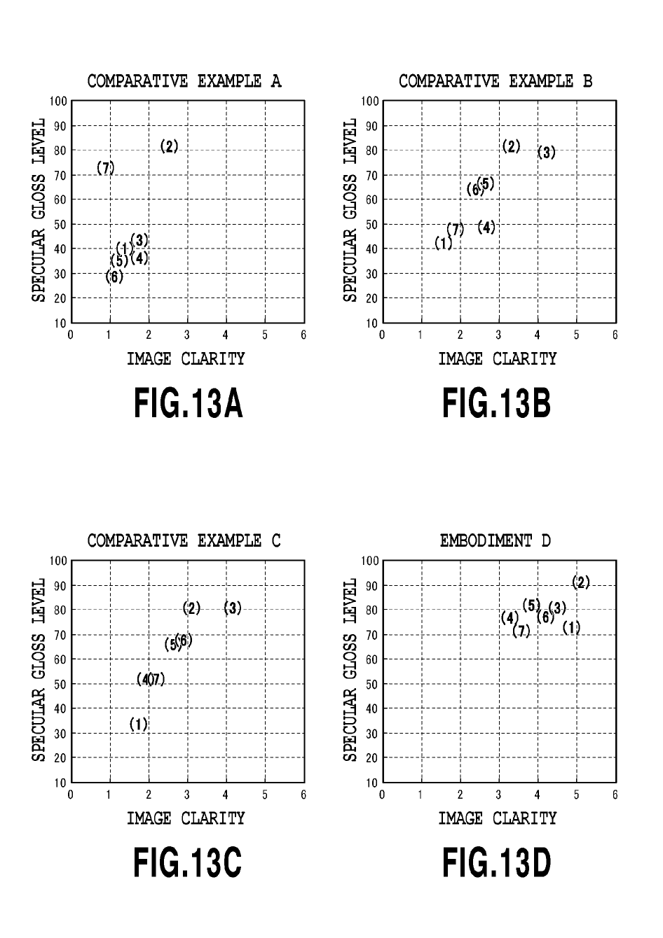

FIG. 9 is a flowchart showing a printing operation of a second method which performs printing by a color ink and a two-stage clear ink application according to the embodiment of the present invention;

FIG. 10 is a flowchart showing a printing operation of a third method which performs printing by a color ink and a two-stage clear ink application according to the embodiment of the present invention;

FIG. 11 is nozzle blocks which each correspond to a width of an area for which printing is completed by a plurality of scans of multi-pass printing with 11 passes in the method shown in FIG. 10;

FIG. 12 is a block diagram showing a construction of a control system of the inkjet printing apparatus; and

FIGS. 13A to 13D are diagrams for explaining measurement results of specular gloss levels and image clarity of the embodiment of the present invention and comparative examples.

### DESCRIPTION THE EMBODIMENTS

Hereinafter, embodiments of the present invention will be described in detail with reference to the accompanying drawings.

The embodiments of the present invention use a pigment ink for printing images and a clear ink which does not contain a coloring agent. The pigment ink is a color ink which contains a color pigment. The pigment ink may be of mono-color, but a plurality of kinds of inks such as cyan, magenta, yellow and black may be prepared. The clear ink is a colorless ink which is prepared by dissolving a vinyl resin (styrene acrylic resin, acid value 170) in water, and containing an organic solvent, and a surfactant therein.

As described above, the present invention is to solve the problem that there are some cases where, when a clear ink is simply applied on a printed matter, smoothness of the printed matter can not be obtained by it. The problem can be described in more detail as follows.

For example, in a case where between two adjacent regions A and B in a surface of a printed matter, a thickness of a pigment ink layer of the region A is larger as compared with a thickness of a pigment ink layer of the region B, and a permeation speed of a clear ink into the pigment ink layer of the region A is higher as compared with that of the region B, much clear ink resins deposit on the region A. As a result, the region A which originally has a thicker pigment ink layer further increases in thickness, and the unevenness on the printed matter surface results in increasing. On the other hand, in a case where the thickness of the pigment ink layer of the region A is small as compared with the thickness of the pigment ink layer of the region B, and the permeation speed of the clear ink into the pigment ink layer of the region A is higher as compared with that of the region B, much clear ink resins deposit on the region A also in this case. However, the region A which originally has a smaller pigment ink layer increases in thickness to reduce the unevenness to the region B.

In general, the film thickness of a pigment ink layer is mainly determined by the solid contents contained in the ink, and the permeation speed of a clear ink is determined by the size of pores formed in the pigment ink layer and the surface energy. Both of them depend greatly on the material property, pigment inks made of different materials according to colors differ in deposition film thickness and permeation speed of the clear ink according to colors. As a result, the applied clear ink increases or decreases unevenness depending on the film thickness of the pigment ink layer and the permeation speed of the clear ink. That is, a smooth surface can not be always obtained by an application of the clear ink. Thus, when a clear ink is applied to a printed matter such as a photograph which is constructed by pigment inks of various kinds or colors, the unevenness is resultantly generated on the printed matter in such a manner that the unevenness is partially reduced and the unevenness is partially increased, and a smooth surface sometimes cannot be obtained.

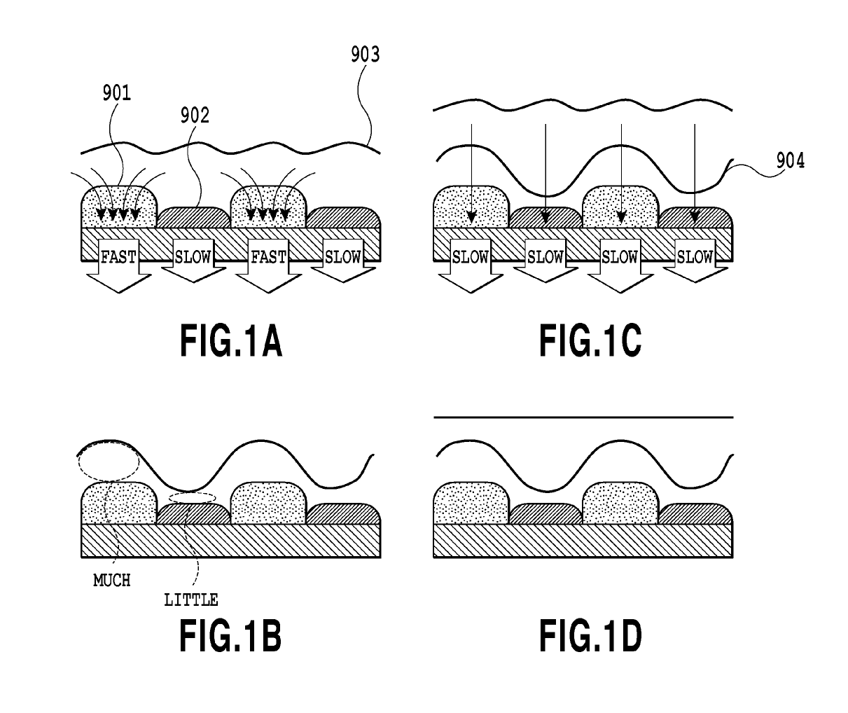

FIGS. 1A to 1D are schematic diagrams for explaining the principle of the present invention which solves the aforementioned problem. As described above, in the printed matter by the pigment ink, the film thickness and the permeation speed of the clear ink may differ according to each kind of the pigment ink. In FIG. 1A, reference numeral 901 denotes a pigment ink with a large film thickness in which a clear ink permeates fast, and reference numeral 902 denotes a pigment ink with a small film thickness in which the clear ink permeates slowly. When a clear ink 903 is applied onto these ink layers, the resin of the clear ink unevenly deposits due to the difference in permeation speed into the pigment ink. FIG. 1B shows this state. As shown in FIG. 1B, much resin deposits on the portion where the clear ink permeates fast, and little resin deposits on the portion where the clear ink permeates slowly. Thus, when the difference in permeation speed of the clear ink occurs in the pigment ink layer, there are some cases where the unevenness occurs by an application of the clear ink. In this case, the printed matter surface does not become smooth, and therefore, the glossiness, in particular, the image clarity can not be improved.

On the other hand, FIG. 1C is a diagram showing a distribution of the permeation speed of the clear ink in the printed matter when the clear ink is further applied onto a clear ink layer 904 formed by applying the clear ink once. As shown in FIG. 1C, the permeation speed of the clear ink which is applied at the second time after the clear ink is applied once becomes slow, and becomes a substantially uniform speed in the printed matter. More specifically, the resin (soluble resin or the like) for use in the clear ink is not formed of large particles, being different from a pigment, and therefore, when the clear ink which is applied at the first time becomes a film, it becomes a film with few pores into which a solution is difficult to permeate. When the second clear ink is applied onto the surface of the clear ink which has become a film once, the clear ink permeates at a substantially uniform permeation speed to be fixed. As a result, the clear ink which is applied at the second time does not have a difference in permeation speed, and therefore, does not generate unevenness, making it possible to form a smooth printed matter surface shown in FIG. 1D. Thereby, the glossiness, in particular, the image clarity of the printed matter can be enhanced.

### (Function of Each Application Step)

The present invention has the feature in which the application process of a clear ink has the application process of two stages. The application of the first stage has the function of forming a film of the clear ink on the region of the printed matter surface where it is desired to obtain gloss, and making the permeation speed of the clear ink into the printed matter uniform. The application of the second stage is the process of applying the clear ink again onto the region to which the clear ink is applied in the application process of the first stage, and has the function of smoothing the printed matter surface.

In the application process of the first stage, the clear ink is applied without a blank space onto the region of the printed matter surface in which it is desired to obtain the gloss. After the clear ink is applied, the clear ink permeates into the region and dries to be fixed, whereby the film of the clear ink is formed on the region of the printed matter surface in which it is desired to obtain the gloss. At this time, the clear ink resin may generate unevenness in accordance with the variation in permeation of the clear ink on the printed matter surface. Therefore, frequently the gloss level is not enhanced in the application process of the first stage. Meanwhile, the region on the printed matter in which it is desired to obtain gloss is covered with the clear ink film, whereby permeation of the solution (clear ink) which will be applied next in this region becomes uniformly slow, and a variation in the permeation speed of the solution is substantially eliminated. As described above, the application process of the first stage performs the function of eliminating the variation in the permeation speed of the solution in the region on the printed matter in which it is desired to obtain the gloss surface.

In the application process of the first stage (first application process), the clear ink is preferably applied without a blank space as described above. If the blank space is formed, the permeation speed of the blank space portion differs from that of the other portions, and the object of making the permeation speed uniform is not attained. It should be noted that the state “without a blank space” described here may have some microscopic blank spaces. More specifically, there is no problem if the clear ink resin substantially uniformly covers 80% of the area in the region of the printed matter surface in which it is desired to obtain the gloss. “Substantially uniform” means the state without a remarkable deviation in the distribution of the blank spaces, and shows that the deviation is such that the standard deviation σ of the coverage factor measurement at 10 spots is 10% or less according to an experiment.

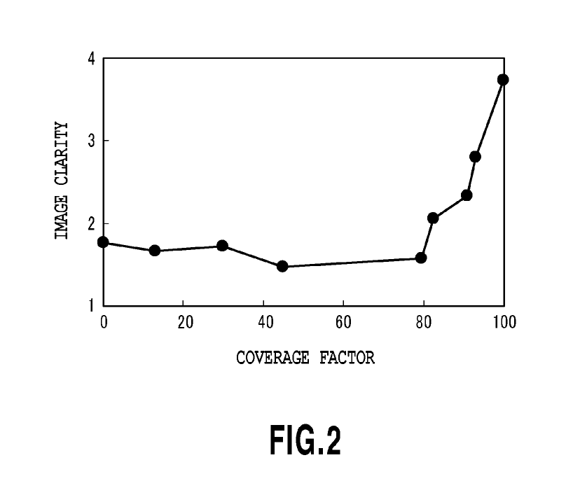

FIG. 2 is a diagram showing a relationship between the coverage factor of the clear ink resin on a printed matter surface and image clarity which is one of the indexes of a gloss level. More specifically, FIG. 2 shows the relationship between the coverage factor of the resin layer formed by the clear ink by the first application, and the image clarity which is realized by applying the second clear ink onto the resin layer of the coverage factor. The measuring method of the image clarity and the production method of the printed matter will be described later. Further, in the example shown in FIG. 2, PFC-103BK of Canon Inc. is used as the pigment ink, and what is printed with the pigment ink with a printing duty of 75% is used as the printed matter. Here, “printing duty” is more specifically determined by the image data of the pigment ink when the image data is printed with the pigment ink as described above. For example, when image data is configured by 8 bits, the printing duty is 100% in the case of performing printing based on each of the image data of the value of “252”. In the example shown in the figure, the printing duty of 75% corresponds to the image data of the value of approximately “191”. The explanation similarly applies to the printing duty of the following clear ink.

As is obvious from FIG. 2, the effect of enhancing a gloss level can be obtained when the coverage factor is 80% or more. More specifically, even if unevenness occurs to the blank space of approximately 20%, the effect of enhancing the gloss level is provided if the other portions can be covered.

For measurement of the coverage factor of the clear ink resin, an optical microscope is used. First, the printed matter after the application of the clear ink of the first stage is photographed by the optical microscope. In this measurement, the photography is performed by using the optical microscope with a ten-power objective lens and a digital camera of 1.2 million pixels. Since the thin film of the clear ink resin deposits on the portion covered with the clear ink, the portion looks so as to change in coloring due to thin film interference. The color which is changed by the thin film interference and the color which is not changed are divided into two regions by image processing software or the like, the area of each of the regions is calculated, by which the coverage factor of the clear ink resin is obtained.

In the application process of the second stage (second application process), the clear ink is applied to the region where the variation in the permeation speed is eliminated by formation of the clear ink layer in the application process of the first stage. The application is such that for the region to which the clear ink is applied in the first stage, the area of 80% or more is substantially uniformly covered with the clear ink resin.

In the application process of the second stage, the clear ink by the application step of the first stage has been preferably formed as a film. Formation of the film advances by the solvent of the clear ink permeating the printed matter or drying for removal. The easiest method of formation of the film is the method which dries the clear ink by leaving it for a fixed time after the application process of the first stage. The time required for formation of the film differs depending on the material of the clear ink and the kind of the printed matter by the pigment ink. The time required for the film formation can be obtained by variously changing the time between the application processes of the first stage and the second stage and measuring the resultant change of image clarity.

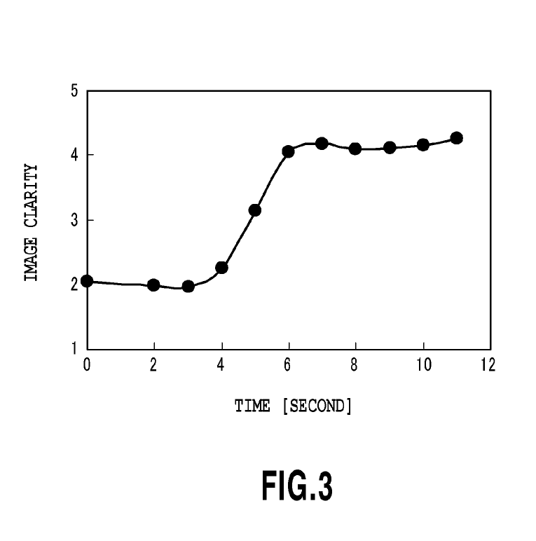

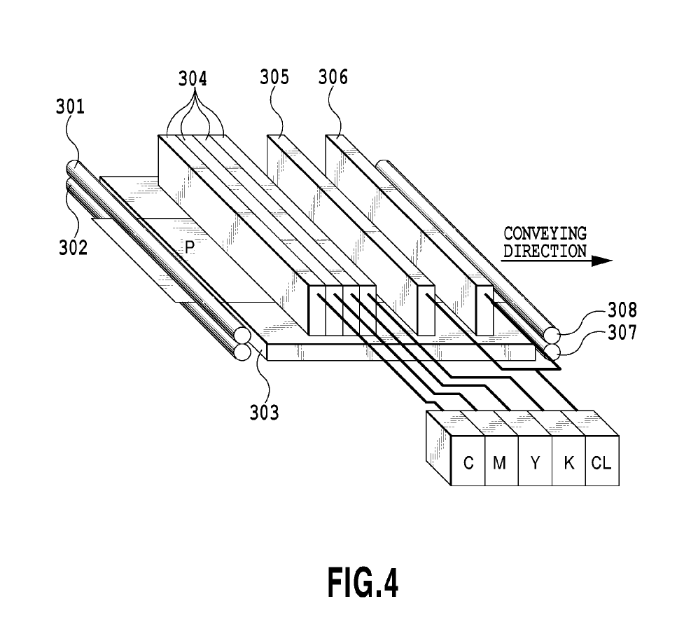

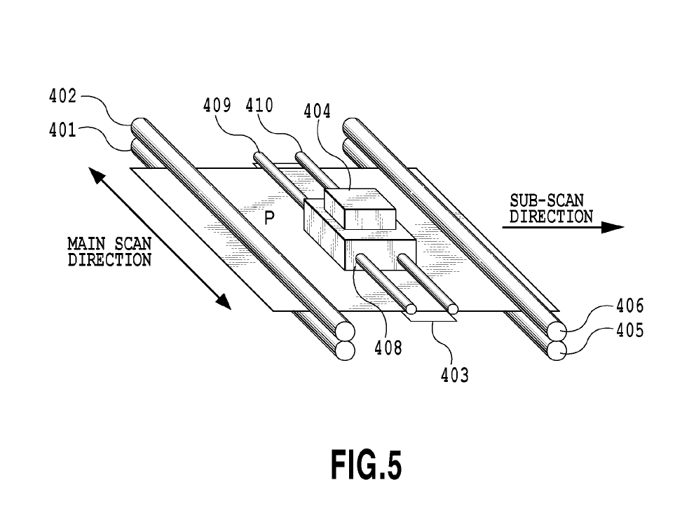

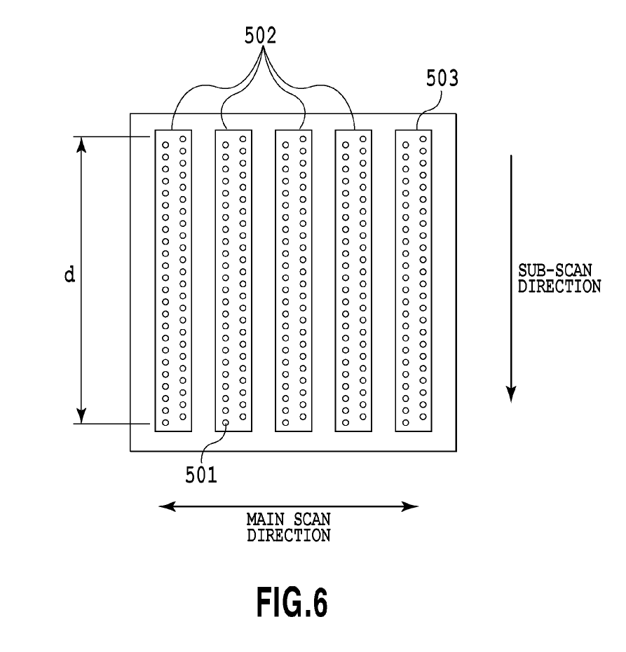

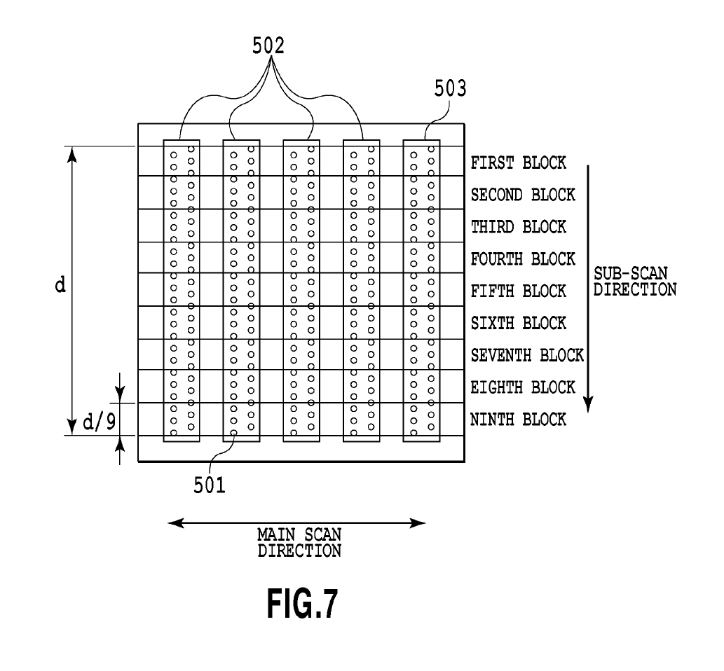

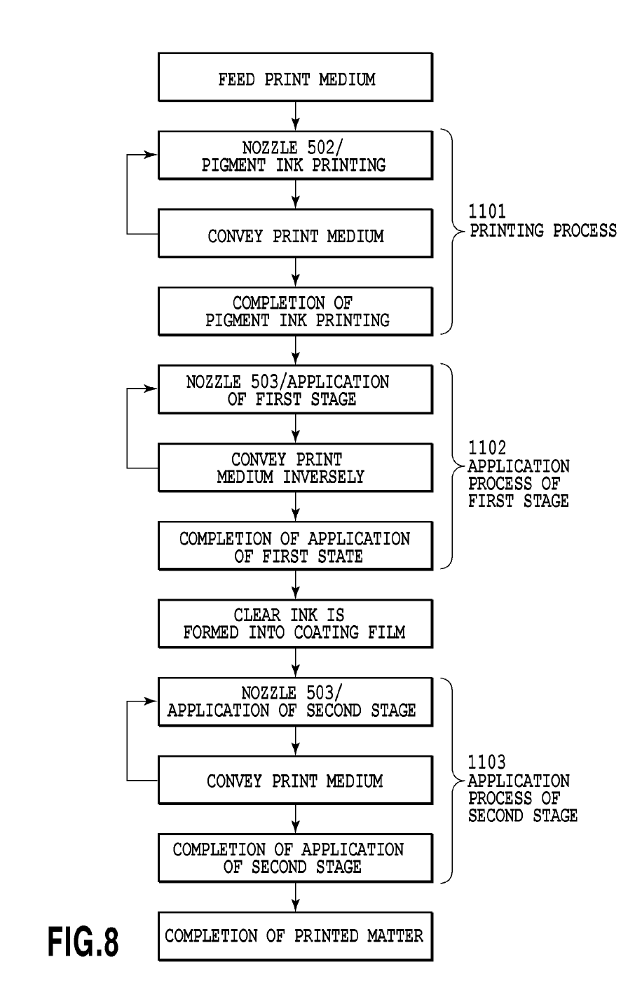

FIG. 3 is a diagram showing a relationship between the time between the application of the first stage and the application of the second stage, and the image clarity. In this example, PFC-101C of Canon Inc. is used as the pigment ink, and the one printed with a printing duty of 75% is used as a printed matter. As is apparent from FIG. 3, by setting an interval of about four seconds or more as the time between the application processes of the first stage and the second stage, the effect of enhancing image clarity is obtained. More specifically, it takes about four seconds or more for the clear ink to be a film in the application process of the first stage. Examples of the method for forming the film may include a method which promotes drying by using a heater and the like in addition to the above.

Each of the application processes may be carried out by a plurality of times in order to perform the function thereof. For example, there may be estimated some cases where by performing the application of the first stage only once, the film of the clear ink is thin, and the effect of reducing the permeation variation is small, depending on the material for use in the clear ink. In such a case, it is desirable to perform the application process of the first stage twice or more. Similarly, there may be estimated some cases where by performing the application of the second stage only once, the unevenness on the printed matter surface still remains though the unevenness is reduced depending on the clear ink material. In such a case, it is desirable to perform the application process of the second stage twice or more.

### (Embodiment of a Line Head Type Inkjet Printing Apparatus)

FIG. 4 is a perspective view showing an outline of a line head type inkjet printing apparatus which can perform the printing of the pigment ink and the subsequent printing of the clear ink of a plurality of stages which are described above. A print medium P is fed onto a conveyance path by a feeding unit (not illustrated) with a feeding motor as a drive power source. Along this conveyance path, a conveying roller 301 and a pinch roller 302 which follows this, and a sheet discharge roller 307 at a more downstream side in the conveyance path and a spur 308 which follows this are provided. The fed print medium P is conveyed in the conveying direction in the figure by the above described conveying roller pair and the above described discharge roller pair. A platen 303 is provided at a printing position opposed to surfaces (ejection surfaces) on which ejection openings of printing heads 304, 305 and 306 are formed, between the above-described two pairs of rollers. Thereby, the print medium P which is conveyed can be supported at the back surface to maintain a distance between the print medium P and the respective ejection surfaces of the printing heads 304, 305 and 306 to be constant. The print medium P which is subjected to printing by ejection of the ink and the clear ink from the printing heads in the printing part on the platen 303 is conveyed in the conveying direction by the pair of the sheet discharge roller 307 and the spur 308, and is discharged onto a sheet discharge tray (not illustrated).

The printing heads 304, 305 and 306 are so-called full line type printing heads in which the ejection openings are arranged over the range equivalent to or larger than the width of the print medium P, and can perform printing on a whole surface of the print medium P by conveying the print medium P once. The four printing heads 304 are printing heads which respectively eject the pigment inks of cyan (C), magenta (M), yellow (Y) and black (K). Further, at a downstream side in the conveying direction of the print medium P, the similar two full line type printing heads 305 and 306 which eject the clear ink are provided. /

By the arrangement of the printing heads, the inks of C, M, Y and K are ejected to the print medium P which is conveyed, from the printing heads 304 according to the printing data, thereby printing an image thereon. The image on the print medium is sequentially opposed to the printing heads 305 and 306, and the clear ink is ejected to the image. That is, the application process of the clear ink in the first stage is performed by the printing head 305. Thereafter, the application process of the clear ink in the second stage is performed by the printing head 306. Here, a space provided in the conveying direction between the printing head 305 and the printing head 306 is a distance corresponding to the aforementioned time during which the clear ink applied in the application process of the first stage becomes the film. Thereby, in the middle where the print medium P is conveyed at a constant speed, the printing process by C, M, Y and K inks, the application process of the first stage by the clear ink, the process of the film formation of the clear ink, and the application process of the second stage by the clear ink are sequentially executed. A heater as a mechanism for promoting the film formation may be disposed between a nozzle array (first nozzle array) of the printing head 305 and a nozzle array (second nozzle array) of the printing head 306, and thereby, the distance between the two printing heads may be reduced.

### (Embodiment of a Serial Type Inkjet Printing Apparatus)

As another mode for realizing the printing method according to the present invention, a serial type inkjet printing apparatus also may be used. FIG. 5 is a perspective view showing an outline of a serial type inkjet printing apparatus. The print medium P is fed to a nip section between a conveying roller 401 and a pinch roller 402 following the conveying roller 401 which are disposed on a conveyance path by an automatic feeding unit (not illustrated) with a sheet feeding motor as a drive source. Thereafter, the print medium P is intermittently conveyed in a sub-scan direction (conveying direction) shown in the figure by a pair of the conveyance roller 401 and the pinch roller 402 and a pair of a sheet discharge roller 405 and a pinch roller 406. A platen 403 is provided along a conveyance path opposed to an ejection surface of a printing head 404, whereby the print medium P is supported at a back surface side, and a distance between the print medium P and the ejection surface of the printing head 404 can be kept constant. The print medium P for which printing is performed in a printing part on the platen 403 is conveyed in the sub-scan direction by the pair of the sheet discharge roller 405 and the pinch roller 406, and is discharged onto a sheet discharge tray (not illustrated).

The printing head 404 is detachably mounted on a carriage 408. The carriage 408 can reciprocate in a main scan direction along two guide rails 409 and 410 by the drive force of a carriage motor, and ejects an ink or a clear ink from the printing head 404 in accordance with printing data in the process of the movement, thus performing printing. Such printing scan by the printing head 404 and the conveyance operation of the print medium are alternately repeated, and thereby, an image is formed on the print medium P stepwise.

FIG. 6 is a diagram showing the printing head 404 as seen from a face side where ejection openings are arranged. In FIG. 6, reference numeral 502 denotes nozzle (ejection openings) arrays for ejecting a pigment ink containing a color pigment of each of C, M, Y and K, and reference numeral 503 denotes a nozzle array for ejecting a clear ink. A width (length) of each of the nozzle arrays in the sub-scan direction is d, and by one time of the scan, printing for the width d can be performed for the print medium. In each of the nozzle arrays, nozzles 501 for ejecting an ink or a clear ink as droplets are arranged by predetermined pitches in the sub-scan direction.

The printing apparatus of the present embodiment has a mode of carrying out multi-pass printing. The multi-pass printing performs conveyance of the print medium P by a width shorter than the above described d in a period between scans of the printing head 404, and thereby, performs a plurality of scans of the printing head for a printing area of the short width. Thereby, printing can be performed by assigning different nozzles in each scan for the area. Thus, a density variation and a streak due to variations in the individual nozzles can be reduced. In general, in the case of M-pass printing which completes an image by printing scans of M times, conveyance of the print medium is performed by a width of d/M in a period between the respective printing scans. Hereinafter, an image area having a width d/M, image of which is completed by M times of scans in such multi-pass printing will be called the same image area. In the printing process mainly using a pigment ink, the multi-pass printing is used. On the other hand, applications of the clear inks of the first stage and the second stage do not aim at formation of an image, and therefore, the multi-pass printing does not necessarily have to be used.

The present embodiment has the mode of applying a clear ink, and the mode of not applying the clear ink, and uses printing methods differing between them. The mode of not applying the clear ink will be described with reference to FIG. 7 which is the diagram similar to FIG. 6. In this mode, among the nozzle arrays 502 for ejecting the colored pigment ink and the nozzle array 503 for ejecting the clear ink, the multi-pass printing is performed by using only the nozzle arrays 502 without using the nozzle array 503 of the clear ink. FIG. 7 shows nozzle blocks each corresponding to a conveyance amount d/9 of the aforementioned print medium in the case of performing the multi-pass printing with 9 passes.

In the mode of applying the clear ink, any one of three printing methods shown as follows can be used.

In the first method, a clear ink application of the first stage is performed after completion of the printing process by color inks, and after completion of the clear ink application of the first stage, a clear ink application of the second stage is performed in sequence.

FIG. 8 is a flowchart showing the printing operation. In FIG. 8, first, in a printing process 1101, multi-pass printing is used with the nozzle arrays 502 of color inks, and an image of a predetermined amount, for example, of one page is printed. At this time, the nozzle array 503 of the clear ink is not used. In the multi-pass printing, in print medium conveyance at one time in a period between scans of the printing head, the conveyance is performed by a distance corresponding to the width d/9 shown in FIG. 7. Thereby, to the same image areas of the width d/9, the first block to the ninth block of the nozzle arrays 502 are sequentially assigned in nine scans, and printing is completed by the respective nozzles. Next, in an application process 1102 of the first stage, after the printing process is completed as described above, the conveying roller 401 and the sheet discharge roller 405 are rotated inversely, and the print medium P is intermittently conveyed in the reverse direction to the sub-scan direction. Subsequently, after each conveyance, by using the nozzle array 503, the clear ink of the first stage is ejected to the image printed in the printing process to be applied thereon. The conveyance amount of the print medium at this time can be set to the width d of the nozzle arrangement range of the nozzle array 503. After the clear ink application of the first stage is completed, if the time is required for forming the film of the clear ink, a wait time is provided. However, in the serial type inkjet printer, it generally takes several seconds to move the carriage in the main scan direction or reverse the conveying direction of the print medium P, and therefore, await time does not have to be provided in many cases. In any case, after the time for film formation is ensured, in an application process 1103 of the second stage, the conveying roller 401 and the sheet discharge roller 405 are rotated in the forward direction to convey the print medium P intermittently in the sub-scan direction. Subsequently, after each conveyance, the clear ink application of the second stage is performed by using the nozzle array 503. The conveyance amount of the print medium at this time also can be set to the width d of the nozzle arrangement range of the nozzle array 503. The printed matter is completed by the above processes. The clear ink of the first stage is applied while the print medium P is conveyed inversely from the sub-scan direction, but the print medium P may be fed again after completion of the printing process, and the clear ink may be applied by the regular printing method which conveys the print medium P in the sub-scan direction.

The second method is executed such that the printing process and the clear ink application of the first stage are completed while conveyance is carried out in the sub-scan direction of one time, and the clear ink application of the second stage is carried out after the completion thereof.

FIG. 9 is a flowchart showing this printing operation. In FIG. 9, in a printing process and an application process 1201 of the first stage, at the time of printing a multi-pass by a plurality of printing scans of the printing head, the printing process by the pigment inks is executed by a predetermined number of times of printing scans, and after the predetermined number of times of the printing scans, the application process of the clear ink in the first stage is executed. More specifically, the multi-pass printing of 9 passes is carried out, and the printing process by the pigment inks is executed by the first to the eighth printing scans onto the same image area, and the clear ink application process of the first stage is performed by the ninth printing scan. In the case of the multi-pass printing of 9 passes, each of the nozzle arrays is used by being divided into the first to the ninth blocks as shown in FIG. 7. For the same image area of the print medium which is conveyed by d/9 in the sub-scan direction each time one printing scan is performed, printing is performed by the first to the eighth printing scans by the first to the eighth blocks of the nozzle arrays 502, and the ninth printing scan by the ninth block of the nozzle array 503. Here, when the time for formation of the film of the clear ink is required, a wait time is provided, but the wait time does not have to be provided in many cases as described above.

After the film formation, in an application process 1202 of the second stage, the conveying roller 401 and the sheet discharge roller 405 are rotated inversely, and clear ink application of the second stage is performed by using the nozzle array 503 while the print medium P is conveyed in the reverse direction from the sub-scan direction. The conveyance amount of the print medium at this time also can be set to the width d of the nozzle arrangement range of the nozzle array 503. Though the clear ink of the second stage is applied while the print medium P is conveyed in the reverse direction from the sub-scan direction, the clear ink may be applied by the regular printing method which feeds the print medium P again after completion of the printing process, and conveys the print medium P in the sub-scan direction.

The third method is constructed such that the printing process, the clear ink application of the first stage, and the clear ink application of the second stage are carried out while performing conveyance at one time in the sub-scanning direction.

FIG. 10 is a flowchart showing this printing operation. Further, FIG. 11 is a diagram showing nozzle blocks each corresponding to a width d/11 of an area for which printing is completed by a plurality of scans of multi-pass printing with 11 passes in the present method. In the present method, when the multi-pass printing is performed by the number of plural times of printing scans, the printing process by a pigment ink is executed by the predetermined number of times of printing scans (1301 in FIG. 10), and after the predetermined number of times of the printing scans, the application process of the first stage of the clear ink (1302 in FIG. 10) is executed. A scan which does not apply anything is performed as needed for obtaining a time for film formation of the clear ink (1303 in FIG. 10), and an application process of the second stage of the clear ink (1304 in FIG. 10) is executed by the final printing scan. More specifically, the multi-pass printing of 11 passes is carried out. At this time, the printing process by the pigment ink is executed in the first to the eighth printing scans for the same image area (1301), and the clear ink application process of the first stage is executed in the ninth printing scan (1302). In the tenth printing scan, the process of ejecting no ink is executed for obtaining the time for clear ink film formation (1303: hereinafter, described as a dry process), and the clear ink application process of the second stage is executed in the eleventh printing scan (1304). In the case of the multi-pass printing of 11 passes, each of the nozzle arrays is used by being divided into the first to the eleventh blocks as shown in FIG. 11. For the same image area of the print medium which is conveyed by a width d/11 in the sub-scan direction each time one printing scan is performed, the first to the eighth printing scans by the first to the eighth blocks of nozzles 702 and the ninth printing scan by the ninth block of the nozzle 703 are performed. Further, in the tenth scan, all the nozzle arrays in the tenth block do not eject the ink and the clear ink, and the eleventh printing scan by the eleventh block of the nozzle 703 is performed, whereby an image is printed. When the time for formation of the clear ink film is within the time of performing one scan, the dry process is not needed. In such a case, the multi-pass printing with 10 passes is performed. In reverse, if the time for formation of the film of the clear ink exceeds the time of performing two scans, the dry process corresponding to two passes or more is preferably prepared.

### (Structure of a Control System in the Inkjet Printing Apparatus)

FIG. 12 is a block diagram showing the construction of a control system in the inkjet printing apparatus according to the above described present embodiment. In the figure, reference numeral 31 denotes an image data input section, which receives image data inputted from a scanner, a digital camera or the like, and image data stored in the hard disk of a personal computer or the like. In the present embodiment, positions on an image and gloss level data representing gloss levels (binary data of providing/not providing a high gloss) are inputted in combination here. There are mainly two kinds of input methods of gloss level data. One is the method in which a user produces image data and gloss level data and inputs them into the image data unit together. The other one is the method in which a user selects a regular gloss and a high gloss as the image quality, and inputs the data for aiming at providing the high gloss to the entire surface of an image, which is prepared in advance, in the image data input section as gloss level data at the time of selection of the high gloss. In this case, at the time of selection of the regular gloss, the data for aiming at not providing the high gloss to the entire image surface, which is prepared in advance, is inputted in the image data input section as the gloss level data. Reference numeral 32 denotes an operation part, which includes various keys for an operator to give instructions of setting various parameters, starting printing thereof, and the like. Reference numeral 33 denotes a CPU which is a central processing section, and the CPU 33 performs control of the processes and the like described above with FIGS. 8 to 10 in accordance with programs read from a storage medium 34.

For the storage medium 34, a ROM, an FD, a CD-ROM, an HD, a memory card, a magneto-optical disk and the like can be applied. The storage contents stored in the storage medium 34 include information 34a relating to the kind of the print medium and information 34b related to inks. Further, the contents also include information 34c relating to presence or absence and the position of a defect nozzle, information 34d relating to the environment such as a temperature and humidity at the time of printing, various control programs 34e and the like. Reference numeral 35 denotes a RAM, which is used as a work area at the time of execution of the various programs stored in the storage medium 34, and as a temporary save area of needed data at the time of error processing. The gloss level data of giving/not giving the high gloss to the entire image surface described above is also stored herein. Further, various data stored in the storage medium 34 also can be temporarily copied in the RAM 35. The CPU 33 can change the copied data content in the storage medium 34, and can further proceeds with image processing while referring to the changed data.

Reference numeral 36 denotes an image data processing section. The image data processing section 36 executes quantization processing of converting multi-value image data inputted from the image data input section 31 into ejection data of a lower-level value which the printing head can print. For example, when the data inputted from the image data input section 31 is multi-value image data which is expressed by 8 bits (256 gradation levels) x three colors (RGB), the image data processing section 36 executes the process of separating the data into four (C, N, Y, K) of gray scale data, first. Next, based on the gray scale data of each separated color, the data is converted into dot data which the corresponding printing head can print. Here, when the printing head is capable of printing with only two pieces of information composed of ejection and non-ejection, data is converted into binary data in accordance with a dot arrangement pattern which is defined as any one of printing and non-printing. Further, in a case where the printing head can control an ejection amount by dividing it in a plurality of stages, the data value is reduced to the number of stages with which printing is enabled. At this time, as the method for reducing a data value, a generally known multi-value error diffusion method can be used. Further, other arbitrary halftone processing methods such as an average density conservation method and a dither matrix method can be used. In regard to gloss level data, the data is converted into dot data which the corresponding printing head can print in accordance with the position on the image and the binary data of giving/not giving the high gloss. The conversion method is similar to the aforementioned image data, but in the portion which is given the high gloss, dot data is created so that the application amount of the clear ink is an amount to the extent that 80% or larger of the area of the region in which it is desired to obtain a gloss is covered with the clear ink resin. That is, the image data with the printing duty being 80% is set, and, based on the image data, the above-described dot data is created. With regard to the portion which is not given the high gloss, data that shows no dot arrangement is created.

In the case of performing the multi-pass printing by using the serial type inkjet printing apparatus or in the case of the printing head having a plurality of nozzle arrays of the same color, among the above-described constructions, the process of dividing an image for the scans or nozzle arrays is executed in the image data processing section 36. More specifically, in the case of the multi-pass printing, ejection is dispersed to a plurality of printing scans, and in the case of having a plurality of nozzles, ejection is dispersed to the nozzle arrays. The method may include the case of dividing the aforesaid gray scale data into more (low-density) data at the time of creation of the aforesaid gray scale data, and the method of integration of masks, which are set for each path and each nozzle array, for the dot data.

Reference numeral 37 denotes an image printing part which performs image output, which generates pulses for driving the printing head in accordance with the ejection pattern created by the image data processing section 36, and ejects an ink from ejection openings of the printing head. Reference numeral 38 denotes a bus which transfers various data, which transmits address signals, data, control signals and the like in the storage device.

### EXAMPLES

Hereinafter, with respect to the printed matter outputted by the first clear ink application method using the serial type inkjet printing apparatus among the aforementioned constructions, the examination content for verification of glossiness and the result will be described.

First, the clear ink was used, which was obtained by being prepared with the following composition and thereafter, being adjusted with a potassium hydroxide solution so that pH was 9.

| | | |
|---|---|---|
| Styrene acrylic resin (acid value 170) | 4 | parts |
| Glycerin | 7.5 | parts |
| Surfactant (Acetylenol) | 1 | part |
| Surfactant (BYK333) | 1 | part |

| | |
|---|---|
| Pure water | remaining part |

Further, as the pigment inks, PFI-101C (hereinafter, cyan), PFI-101M (hereinafter, magenta), PFI-101Y (hereinafter, yellow), and PFI-103BK (hereinafter, black) made by Canon Inc. were used. As the printing apparatus, Inkjet Printer iPF-5100 made by Canon Inc. was used, and the resolution at the time of printing was set at 1200 dpi (dot/inch) in the sub-scan direction, and at 2400 dpi in the main scan direction. Further, as the print medium, LFM-GP101R made by Canon Inc. was used. The volume per droplet of the ink is 4.8 pico-liter.

For evaluation of the gloss level, the following two kinds of methods were used. As the specular gloss level, 20-degree gloss value was adopted as the specular gloss level by using GMX-203 made by MURAKAMI COLOR RESEARCH LABORATORY CO., Ltd. A higher value of the 20-degree gloss means a higher specular gloss level.

With regard to image clarity, the value of the sharpness which was measured was adopted as the value of the image clarity by using DIAS DOI Image Analysis System made by QEA Inc. The sharpness value is defined as follows. With a white LED as a light source, a knife edge is located between the light source and a measurement sample, and the reflection image of the knife edge on the sample is photographed by a CCD camera (three hundred thousand pixels: 5 per pixel). The pixel visual field is 2.4 mm square. The luminance distribution of the knife edge portion of the reflection image is subjected to the first derivation, and the inverse of the half-value width thereof is defined as the Sharpness value. Accordingly, as a Sharpness value is the larger, the sharper reflection image is obtained, which means that the image clarity is high.

FIGS. 13A to 13D are diagrams for explaining the results of measurement of the gloss levels of the present embodiment and comparative examples. Comparative example A shown in FIG. 13A shows the respective gloss levels of the printed matter of black, cyan, yellow and magenta with a duty of 75%, and the printed matter of secondary color red (yellow+magenta), secondary color green (cyan+yellow) and secondary color blue (cyan+magenta) with a duty of 120% (each color with a duty of 60%), by using only pigment inks without using a clear ink. In the figures, the axis of abscissa represents image clarity, and the axis of ordinate represents a specular gloss level. The plotted numeral values correspond to the colors of the printed matters, that is, (1) black, (2) yellow, (3) magenta, (4) cyan, (5) secondary color of red, (6) secondary color of green and (7) secondary color of blue.

Comparative example B shown in FIG. 13B shows the gloss level of the printed matter obtained by applying a clear ink with a duty of 50% to comparative example A. Comparative example C shown in FIG. 13C shows the gloss level of the printed matter obtained by applying a clear ink with a duty of 100% to comparative example A. The present embodiment D shown in FIG. 13D shows the gloss level of the printed matter obtained by printing a clear ink to comparative example A by the printing method of the present embodiment. At this time, both the clear ink application of the first stage and the clear ink application of the second stage are performed with a printing duty of 50%. The “duty” is the value which is calculated according to the expression of duty (%)=number of actual printing dots/(the number of vertical pixels×the number of lateral pixels)×100. In the expression, “the number of actual printing dots” is the number of actual printing dots per unit region. Further, “the number of vertical pixels” and “the number of lateral pixels” are the number of vertical pixels and the number of lateral pixels each per unit region.

As is understood from FIGS. 13A to 13D, in comparative example A without using the clear ink, the image clarity and the specular gloss level both are low, and significantly vary for each color. In comparative example B, the image clarity and the specular gloss level both are improved as compared with comparative example A by the clear ink application. However, the effect thereof is small, and variation between the respective colors is large. Comparative example C applies twice as many as the clear inks of comparative example B, but hardly has a difference as compared with comparative example B. That is, even if the application amount of the clear ink is increased, the effect of reducing the unevenness on the printed matter does not change. This is because no matter how much the application amount of the clear ink is increased, the effect of reducing the unevenness on the printed matter does not change. This is because no matter how much clear ink is applied, the permeation speed variation on the pigment ink printed matter does not change, and therefore, the unevenness due to the permeation speed variation occurs irrespective of the application amount. In contrast with this, in the embodiment B which has adopted the printing method of the present embodiment, the image clarity and the specular gloss level are both high, a variation for each color is small. The total application amount of the clear ink is the same as that of comparative example C, but in the embodiment D, the clear ink of the first stage and the clear ink of the second stage can exhibit the respective effects sufficiently, thus realizing the high gloss.

As described above, according to the printing method of the present embodiment, the permeation speed variation on the printed matter surface is reduced by the clear ink application of the first stage, the unevenness on the printed mater can be reduced by the clear ink application of the second stage, and both the specular gloss level and the image clarity can be enhanced.

### Other Embodiments

The embodiment described above has an object of obtaining the gloss of the printed matter, and the present invention is also effective for value-added printing which partially gives a high gloss to an arbitrary spot on the printed matter. When a picture and a letter are printed on a pigment ink printed matter with a low gloss by using the present invention, only the portion has a high gloss and can be emphasized. For example, the present invention can be used in such a manner as to give a high gloss to only the picture portion of the document including a picture, give a high gloss to only a commodity product portion of the poster of the commodity product, and print a letter such as no copying” on a printed matter as a latent image. Such value-added printing is already in practical use in the electro-photography and the like, but in the inkjet printing apparatus for printing in pigment inks, such value-added printing is not in practical use since no means for realizing the high gloss is available irrespective of the state of the printed matter (pigment inks which are applied). Use of the present method enables the value-added printing at a lower cost as compared with the electro-photography.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-174765, filed Aug. 3, 2010, which is hereby incorporated by reference herein in its entirety.

What is claimed is:

1. An ink jet printing apparatus that uses a printing head for ejecting pigment ink containing a pigment as a coloring agent and clear ink containing no coloring agent and having film-forming property on a print medium and ejects ink from the printing head to the print medium for performing printing, said apparatus comprising:
a printing unit configured to cause the printing head to eject a plurality of pigment inks, which contain different coloring agents from each other, from the printing head to the print medium for printing an image;
a first applying unit configured to apply the clear ink to at least a part of a region of the image on the print medium, the region being printed by that said printing unit ejects the plurality of pigment inks that contain different coloring agents from each other, by causing the printing head to eject the clear ink to at least the part of the region; and
a second applying unit configured to apply the clear ink to a region, to which the clear ink is applied by said first applying unit, by causing the printing head to eject the clear ink to the region, after said first applying unit applies the clear ink,
wherein at least one time of application of the clear ink is performed by each of said first and second applying units.

2. The ink jet printing apparatus according to claim 1, wherein said first applying unit applies the clear ink at an application amount by which 80% or larger of an area of at least the part of the region of the image on the print medium is covered with the clear ink, and said second applying unit applies the clear ink at an application amount by which 80% or larger of an area of the region to which the clear ink is applied is covered with the clear ink.

3. The ink jet printing apparatus according to claim 1, further comprising a film forming unit configured to form a film of the applied clear ink after said first applying unit applies the clear ink.

4. The ink jet printing apparatus according to claim 1, wherein the printing head
is a printing head having a nozzle array of nozzles arranged over a region corresponding to a width of the print medium that is conveyed, and
along a conveyance path of the print medium, includes a nozzle array for ejecting the pigment ink, a first nozzle array for ejecting the clear ink, which is arranged on a down stream of the nozzle array in the conveyance path, a film forming unit configured to forming a film of the clear ink, which is arranged on a down stream of the first nozzle array in the conveyance path, and a second nozzle array for ejecting the clear ink, which is arranged on a down stream of the film forming unit in the conveyance path.

5. An ink jet printing method that uses a printing head for ejecting pigment ink containing a pigment as a coloring agent and clear ink containing no coloring agent and having film-forming property on a print medium and ejects ink from the printing head to the print medium for performing printing, said method comprising:
a printing step of causing the printing head to eject a plurality of pigment inks, which contain different coloring agents from each other, from the printing head to the print medium for printing an image;
a first applying step of applying the clear ink to at least a part of a region of the image on the print medium, the region being printed by that said printing unit ejects the plurality of pigment inks that contain different coloring agents from each other, by causing the printing head to eject the clear ink to at least the part of the region; and
a second applying step of applying the clear ink to a region, to which the clear ink is applied by said first applying step, by causing the printing head to eject the clear ink to the region, after said first applying step applies the clear ink,
wherein at least one time of application of the clear ink is performed by each of said first and second applying steps.

6. The ink jet printing method according to claim 5, wherein said first applying step applies the clear ink at an application amount by which 80% or larger of an area of at least the part of the region of the image on the print medium is covered with the clear ink, and said second applying step applies the clear ink at an application amount by which 80% or larger of an area of the region to which the clear ink is applied is covered with the clear ink.

7. The ink jet printing method according to claim 5, further comprising a film forming step of forming a film of the applied clear ink after said first applying step applies the clear ink.

8. The inkjet printing method according to claim 5, wherein the printing head
is a printing head having a nozzle array of nozzles arranged over a region corresponding to a width of the print medium that is conveyed, and
along a conveyance path of the print medium, includes a nozzle array for ejecting the pigment ink, a first nozzle array for ejecting the clear ink, which is arranged on a down stream of the nozzle array in the conveyance path, a film forming step configured to forming a film of the clear ink, which is arranged on a down stream of the first nozzle array in the conveyance path, and a second nozzle array for ejecting the clear ink, which is arranged on a down stream of the film forming step in the conveyance path.
